(19) United States
(12) Patent Application Publication
(10) Pub. No.: US 2024/0153695 A1
(43) Pub. Date: May 9, 2024

(54) INDUCTOR COMPONENT

(71) Applicant: Murata Manufacturing Co., Ltd., Kyoto-fu (JP)

(72) Inventor: Keisuke KUNIMORI, Nagaokakyo-shi (JP)

(73) Assignee: Murata Manufacturing Co., Ltd., Kyoto-fu (JP)

(21) Appl. No.: 18/503,917

(22) Filed: Nov. 7, 2023

(30) Foreign Application Priority Data
Nov. 8, 2022 (JP) 2022-178847

(51) Int. Cl. H01F 27/32; H01F 27/28

(52) U.S. Cl. CPC H01F 27/323; H01F 27/2823

(57) ABSTRACT

An inductor component capable of reducing an electrical resistance of an inductor wire includes an element body; an inductor wire that is provided in the element body and wound on a plane; and an insulation wall that is provided on both side surfaces of the inductor wire in a direction orthogonal to an extension direction of the inductor wire and parallel to the plane. The insulation wall including a first portion provided on an inner peripheral surface of an innermost periphery of the inductor wire and a second portion provided on an outer peripheral surface of an outermost periphery of the inductor wire. Also, in a section orthogonal to the extension direction of the inductor wire, at least one of the first portion and the second portion being inclined with respect to a first direction orthogonal to the plane.

### CROSS-REFERENCE TO RELATED APPLICATION

This application claims benefit of priority to Japanese Patent Application No. 2022-178847, filed Nov. 8, 2022, the entire content of which is incorporated herein by reference.

### BACKGROUND

### Technical Field

The present disclosure relates to an inductor component.

### Background Art

Conventionally, as an inductor component, there is an inductor component described in Japanese Patent No. 6879355. The inductor component includes an element body, an inductor wire provided in the element body and wound on a plane, and a resin wall provided on a side surface of the inductor wire. The width of the resin wall located at the innermost periphery of the inductor wire is larger than the width of the resin wall located between the resin wall located at the innermost periphery and the resin wall located at the outermost periphery.

### SUMMARY

However, in a conventional inductor component, the width of the resin wall located at the innermost periphery of the inductor wire is relatively larger, and thus, the wire width of the inductor wire may become smaller, and the electrical resistance of the inductor wire may become larger.

Therefore, the present disclosure provides an inductor component capable of reducing the electrical resistance of an inductor wire.

An inductor component according to one aspect of the present disclosure includes an element body; an inductor wire that is provided in the element body and wound on a plane; and an insulation wall that is provided on both side surfaces of the inductor wire in a direction orthogonal to an extension direction of the inductor wire and parallel to the plane. The insulation wall including a first portion provided on an inner peripheral surface of an innermost periphery of the inductor wire and a second portion provided on an outer peripheral surface of an outermost periphery of the inductor wire. Also, in a section orthogonal to the extension direction of the inductor wire, at least one of the first portion and the second portion being inclined with respect to a first direction orthogonal to the plane.

According to the aspect, the sectional area of the inductor wire can be increased as compared with the case where at least one of the first portion and the second portion is not inclined with respect to the first direction, and thus, the electrical resistance of the inductor wire can be reduced.

According to the inductor component which is one aspect of the present disclosure, it is possible to reduce the electrical resistance of the inductor wire.

### BRIEF DESCRIPTION OF THE DRAWINGS

FIG. 1 is a schematic plan view illustrating a first embodiment of an inductor component;

FIG. 2 is a sectional view taken along II-II of FIG. 1;

FIG. 3 is a sectional view taken along III-III of FIG. 1;

FIG. 4 is a schematic sectional view illustrating a modification of the inductor component;

FIG. 5A is an explanatory diagram illustrating a manufacturing method of the inductor component;

FIG. 5B is an explanatory diagram illustrating a manufacturing method of the inductor component;

FIG. 5C is an explanatory diagram illustrating a manufacturing method of the inductor component;

FIG. 5D is an explanatory diagram illustrating a manufacturing method of the inductor component;

FIG. 5E is an explanatory diagram illustrating a manufacturing method of the inductor component;

FIG. 5F is an explanatory diagram illustrating a manufacturing method of the inductor component;

FIG. 5G is an explanatory diagram illustrating a manufacturing method of the inductor component;

FIG. 5H is an explanatory diagram illustrating a manufacturing method of the inductor component;

FIG. 5I is an explanatory diagram illustrating a manufacturing method of the inductor component;

FIG. 5J is an explanatory diagram illustrating a manufacturing method of the inductor component;

FIG. 5K is an explanatory diagram illustrating a manufacturing method of the inductor component;

FIG. 5L is an explanatory diagram illustrating a manufacturing method of the inductor component;

FIG. 5M is an explanatory diagram illustrating a manufacturing method of the inductor component;

FIG. 6 is a schematic plan view illustrating a second embodiment of the inductor component;

FIG. 7 is a sectional view taken along VII-VII of FIG. 6; and

FIG. 8 is an enlarged view of a portion A of FIG. 7.

### DETAILED DESCRIPTION

Hereinafter, an inductor component which is one aspect of the present disclosure will be described in detail with reference to illustrated embodiments. Note that the drawings include some schematic drawings, and may not reflect actual dimensions and ratios.

### First Embodiment

(Configuration)

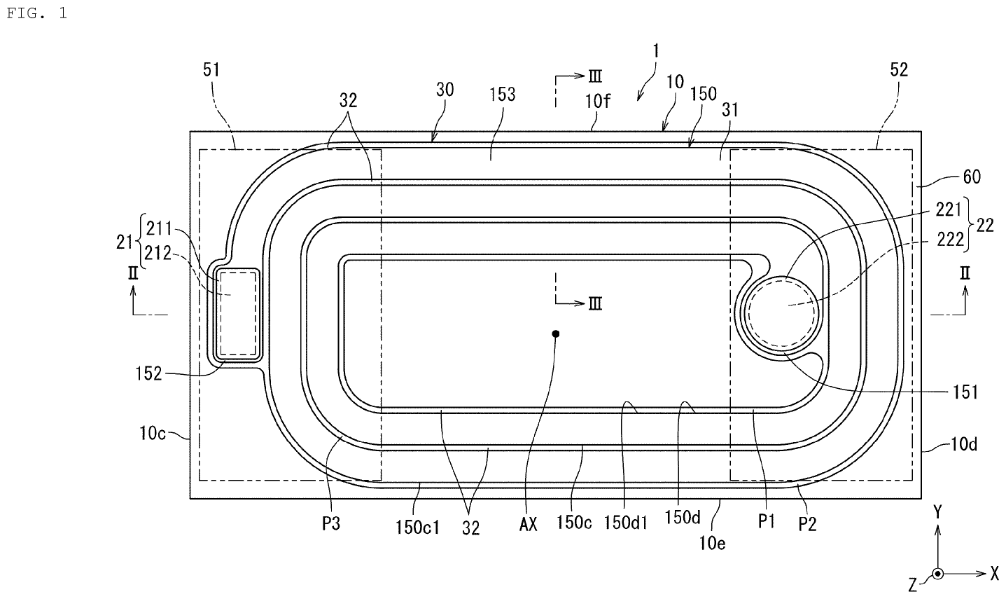

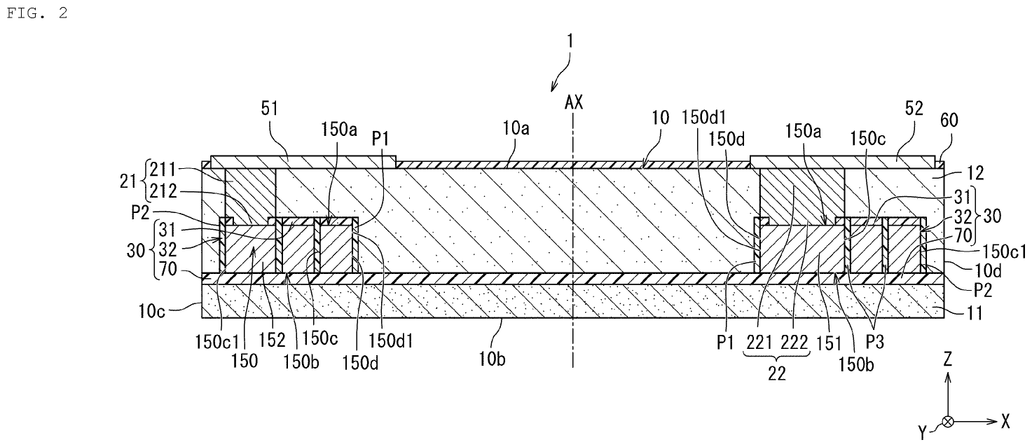

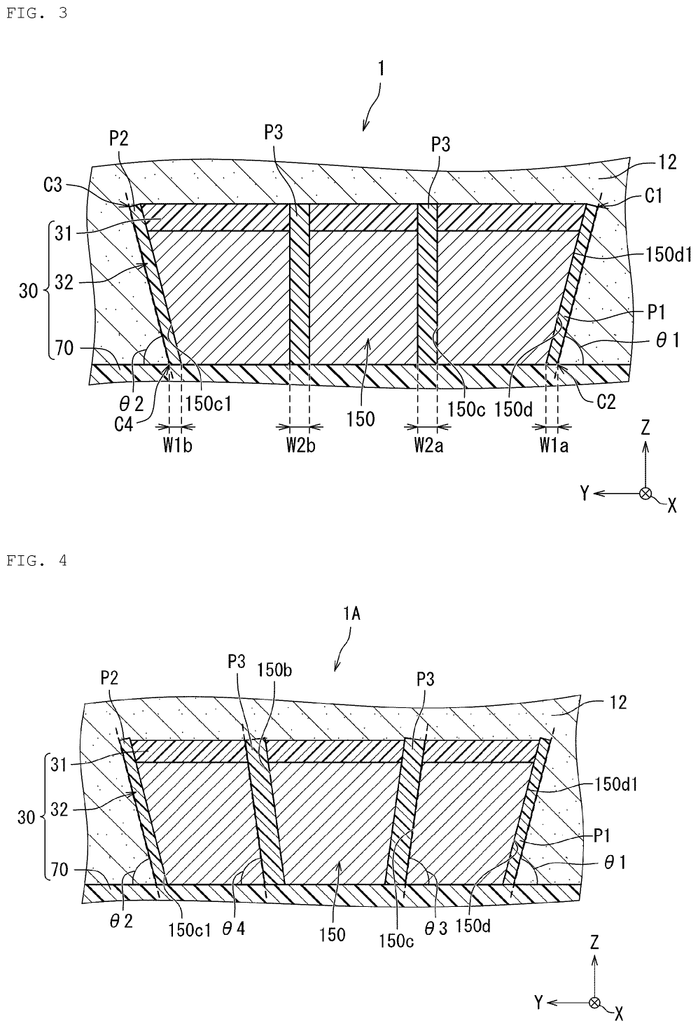

FIG. 1 is a schematic plan view illustrating a first embodiment of an inductor component. FIG. 2 is a sectional view taken along II-II of FIG. 1. FIG. 3 is a sectional view taken along III-III of FIG. 1. In FIGS. 2 and 3, for convenience, a seed layer is omitted. FIG. 3 corresponds to an example of “section orthogonal to an extension direction of the inductor wire” recited in the claims.

For example, an inductor component 1 is mounted on an electronic device such as a personal computer, a DVD player, a digital camera, a TV, a mobile phone, or car electronics, and has a rectangular shape as a whole. However, the shape of the inductor component 1 is not particularly limited, and may be a columnar shape, a polygonal columnar shape, a truncated cone shape, or a polygonal frustum shape.

As illustrated in FIGS. 1 to 3, the inductor component 1 includes an element body 10, an inductor wire 150 provided in the element body 10 and wound on a plane, an insulation layer 30 covering an outer surface of the inductor wire 150, a first extended wire 21 and a second extended wire 22 provided in the element body 10 in a manner that an end surface is exposed from a first principal surface 10a of the element body 10, a first external terminal 51 and a second external terminal 52 exposed on the first principal surface 10a of the element body 10, and a covering film 60 provided on the first principal surface 10a of the element body 10.

The shape of the element body 10 is not particularly limited, and is a rectangular parallelepiped shape according to this embodiment. The outer surface of the element body 10 includes the first principal surface 10a and a second principal surface 10b, and a first side surface 10c, a second side surface 10d, a third side surface 10e, and a fourth side surface 10f that are located between the first principal surface 10a and the second principal surface 10b and connect the first principal surface 10a and the second principal surface 10b. The first principal surface 10a and the second principal surface 10b face each other. The first side surface 10c and the second side surface 10d face each other. The third side surface 10e and the fourth side surface 10f face each other.

In the drawing, a thickness-wise direction of the element body 10 is defined as a Z direction, a direction from the second principal surface 10b toward the first principal surface 10a is defined as a forward Z direction, and the direction opposite to the forward Z direction is defined as a reverse Z direction. In this description, of the first principal surface 10a and the second principal surface 10b, the principal surface side on which the external terminals 51, 52 are provided is defined as the upper side. According to this embodiment, the forward Z direction is the upper side. In a plane orthogonal to the Z direction of the element body 10, a length direction that is a longitudinal direction of the element body 10 and is a direction in which the first external terminal 51 and the second external terminal 52 are arranged is defined as an X direction, and a width direction of the element body 10 that is a direction orthogonal to the length direction is defined as a Y direction. In the X direction, the direction from the first side surface 10c toward the second side surface 10d is defined as a forward X direction, and the direction opposite to the forward X direction is defined as a reverse X direction. In the Y direction, the direction from the third side surface 10e toward the fourth side surface 10f is defined as a forward Y direction, and the direction opposite to the forward Y direction is defined as a reverse Y direction. The Z direction corresponds to an example of “first direction” recited in the claims.

The element body 10 includes a first magnetic layer 11 and a second magnetic layer 12 sequentially disposed in the forward Z direction. Here “sequentially” merely indicates the positional relation between the first magnetic layer 11 and the second magnetic layer 12, and is irrelevant to the sequence of forming the first magnetic layer 11 and the second magnetic layer 12.

Each of the first magnetic layer 11 and the second magnetic layer 12 contains a magnetic powder and a resin containing the magnetic powder. The resin is an organic insulating material that is, for example, epoxy, a mixture of epoxy and acrylic, or a mixture of epoxy, acrylic and other materials. The magnetic powder is, for example, an FeSi-based alloy such as FeSiCr, an FeCo-based alloy, an Fe-based alloy such as NiFe, or an amorphous alloy thereof. The magnetic powder may be ferrite. It is preferable that the average particle diameter of the magnetic powder is 5 μm or less. Note that the first magnetic layer 11 and the second magnetic layer 12 may be ferrite, a sintered body of the magnetic powder, etc. which do not contain an organic resin.

The inductor wire 150 is wound on an XY plane between the first magnetic layer 11 and the second magnetic layer 12. Specifically, the first magnetic layer 11 exists in the reverse Z direction with respect to the inductor wire 150, and the second magnetic layer 12 exists in the forward Z direction and in the direction orthogonal to the forward Z direction with respect to the inductor wire 150. The XY plane corresponds to an example of “plane” recited in the claims.

The inductor wire 150 extends in a spiral shape. Specifically, the inductor wire 150 is spirally wound in a clockwise direction from an outer peripheral end toward an inner peripheral end when viewed from the Z direction. The inductor wire 150 has a central axis AX. According to this embodiment, the axis AX direction is parallel to the Z direction. Here “parallel” includes an absolutely parallel state as well as a substantially parallel state.

It is preferable that the number of turns of the inductor wire 150 is 1 turn or more. Thus, the inductance value can be improved. “1 turn or more” refers to a state in which, in a section orthogonal to the axis of the inductor wire, the inductor wire has portions that are adjacent in a radial direction and run parallel in a winding direction as viewed from a direction of the axis, and “less than 1 turn” refers to a state in which, in a section orthogonal to the axis, the inductor wire does not have the portions that are adjacent in the radial direction and run parallel in the winding direction as viewed from the direction of the axis. According to this embodiment, the number of turns of the inductor wire 150 is 2.5 turns.

The inductor wire 150 includes a wire portion 153 wound on the XY plane, and a first pad portion 151 and a second pad portion 152 provided at the end portions in the extension direction of the wire portion 153. The wire portion is a wound portion of the inductor wire, and is a portion of the inductor wire excluding the pad portions. The pad portions are portions to which another wire such as an extended wire is connected, and are formed to be wider than the wire portion. Specifically, the first pad portion 151 is provided at the inner peripheral end of the inductor wire 150, and the second pad portion 152 is provided at the outer peripheral end of the inductor wire 150.

The inductor wire 150 has a top surface 150a and a bottom surface 150b opposite to each other in the Z direction. Specifically, the inductor wire 150 has the top surface 150a facing the forward Z direction (i.e., upper side) and the bottom surface 150b facing the reverse Z direction. The inductor wire 150 has both of the side surfaces 150c, 150d connecting the top surface 150a and the bottom surface 150b. In other words, the inductor wire 150 has both of the side surfaces 150c, 150d in a direction orthogonal to the extension direction of the inductor wire 150 and parallel to the XY plane (hereinafter, this direction is referred to as “wire width direction”). Specifically, the inductor wire 150 has the first side surface 150c facing radially outward and the second side surface 150d facing radially inward.

The second pad portion 152 of the inductor wire 150 is connected to the first external terminal 51 with the first extended wire 21, which is in contact with the top surface of the second pad portion 152, interposed therebetween. The first pad portion 151 of the inductor wire 150 is connected to the second external terminal 52 with the second extended wire 22, which is in contact with the top surface of the first pad portion 151, interposed therebetween. With the above configuration, the inductor wire 150 is electrically connected to the first external terminal 51 and the second external terminal 52.

It is preferable that the inductor wire 150 is made of Au, Pt, Pd, Ag, Cu, Al, Co, Cr, Zn, Ni, Ti, W, Fe, Sn, In, or compounds thereof. The inductor wire 150 is formed by electrolytic plating, for example. The inductor wire 150 may be formed by an electroless plating method, a sputtering method, a vapor deposition method, a coating method, or the like.

The first extended wire 21 extends in the forward Z direction from the top surface of the second pad portion 152 of the inductor wire 150, and penetrates the insides of the insulation layer 30 and the second magnetic layer 12. It is preferable that the first extended wire 21 is made of Cu, Ag, Au, Fe, or compounds thereof. That is, the first extended wire 21 includes a first via wire 212 which is provided on the top surface of the second pad portion 152 of the inductor wire 150 and penetrates the inside of the insulation layer 30, and a first columnar wire 211 which extends in the forward Z direction from the top surface of the first via wire 212, penetrates the inside of the second magnetic layer 12, and has an end surface exposed on the first principal surface 10a of the element body 10. The via wire is a conductor having a wire width (diameter and sectional area) smaller than that of the columnar wire.

The second extended wire 22 extends in the forward Z direction from the top surface of the first pad portion 151 of the inductor wire 150, and penetrates the insides of the insulation layer 30 and the second magnetic layer 12. It is preferable that the second extended wire 22 is made of Cu, Ag, Au, Fe, or compounds thereof. The second extended wire 22 includes a second via wire 222 which is provided on the top surface of the first pad portion 151 of the inductor wire 150 and penetrates the inside of the insulation layer 30, and a second columnar wire 221 which extends in the forward Z direction from the top surface of the second via wire 222, penetrates the inside of the second magnetic layer 12, and has an end surface exposed on the first principal surface 10a of the element body 10. It is preferable that the first and second extended wires 21, 22 are made of the same material as the inductor wire 150.

The first and second external terminals 51, 52 are provided on the first principal surface 10a of the element body 10. The first and second external terminals 51, 52 are made of a conductive material, and have a three-layer configuration in which, for example, Cu having low electrical resistance and excellent stress resistance, Ni having excellent corrosion resistance, and Au having excellent solder wettability and reliability are arranged in this order from the inside to the outside.

The first external terminal 51 is in contact with the end surface of the first extended wire 21 exposed from the first principal surface 10a of the element body 10 and is electrically connected to the first extended wire 21. Thus, the first external terminal 51 is electrically connected to the second pad portion 152 of the inductor wire 150. The second external terminal 52 is in contact with the end surface of the second extended wire 22 exposed from the first principal surface 10a of the element body 10 and is electrically connected to the second extended wire 22. Thus, the second external terminal 52 is electrically connected to the first pad portion 151 of the inductor wire 150. In FIG. 1, the first and second external terminals 51, 52 are indicated by two-dot chain lines for convenience.

The insulation layer 30 is made of an insulating material containing no magnetic body. It is preferable that the insulating material is made of, for example, any one of epoxy, acrylic, phenol, or polyimide, or a mixture thereof. The insulation layer 30 has an underlying insulation layer 70 covering the bottom surface 150b of the inductor wire 150, an interlayer insulation layer 31 covering the top surface 150a of the inductor wire 150, and an insulation wall 32 covering both of the side surfaces 150c, 150d of the inductor wire 150. The materials of the underlying insulation layer 70, the interlayer insulation layer 31, and the insulation wall 32 may be the same or different from each other.

The underlying insulation layer 70 is laminated on the first magnetic layer 11 in a manner of covering the entire upper surface of the first magnetic layer 11. The inductor wire 150 is laminated on the underlying insulation layer 70. The entire bottom surface 150b of the inductor wire 150 is in contact with the upper surface of the underlying insulation layer 70. Thus, it is possible to ensure the electrical insulating properties between the bottom surface 150b of the inductor wire 150 and other conductive members.

The interlayer insulation layer 31 is provided in a region of the top surface 150a of the inductor wire 150 other than the connection regions with the first and second extended wires 21, 22. Thus, it is possible to ensure the electrical insulating properties between the top surface 150a of the inductor wire 150 and other conductive members.

As shown in FIG. 3, the insulation wall 32 is provided on each of the first side surface 150c and the second side surface 150d. The insulation wall 32 is in contact with the entire first side surface 150c and the entire second side surface 150d. The lower surface of the insulation wall 32 is in contact with the upper surface of the underlying insulation layer 70. In short, the insulation wall 32 is provided on an inner peripheral surface 150d1 of the innermost periphery of the inductor wire 150, on an outer peripheral surface 150c1 of the outermost periphery of the inductor wire 150, and between the turns of the inductor wire 150.

The innermost periphery of the inductor wire refers to the inner periphery on the radially inner side of the inductor wire when the number of turns of the inductor wire is less than 1 turn, and refers to the inner periphery on the radially inner side of a portion of the inductor wire that constitutes 1 turn including the inner peripheral end when the inductor wire has 1 or more turns. The outermost periphery of the inductor wire refers to the outer periphery on the radially outer side of the inductor wire when the inductor wire has less than 1 turn, and refers to the outer periphery on the radially outer side of a portion of the inductor wire that constitutes 1 turn including the outer peripheral end when the inductor wire has 1 or more turns.

The insulation wall 32 includes a first portion P1 provided on the inner peripheral surface 150d1 of the innermost periphery of the inductor wire 150, a second portion P2 provided on the outer peripheral surface 150c1 of the outermost periphery of the inductor wire 150, and a third portion P3 other than the first portion P1 and the second portion P2. The third portion P3 is the insulation wall 32 located between the turns of the inductor wire 150. Therefore, when the number of turns of the inductor wire 150 is less than 1 turn, the third portion P3 does not exist. According to this embodiment, each of the first to third portions P1 to P3 is formed into a linear shape in a section orthogonal to the extension direction of the inductor wire 150 (i.e., the section illustrated in FIG. 3). However, the present disclosure is not limited thereto, and each of the first to third portions P1 to P3 may have a curved shape or a shape obtained by combining a curved line and a straight line.

In a section orthogonal to the extension direction of the inductor wire 150, at least one of the first portion P1 and the second portion P2 is inclined with respect to the first direction (Z direction) orthogonal to the XY plane. Preferably, in a section orthogonal to the extension direction of the inductor wire 150, at least one of the first portion P1 and the second portion P2 is inclined in a manner that the width of the inductor wire 150 in the direction parallel to the XY plane increases toward the forward or reverse direction of the first direction, and according to this embodiment, both the first portion P1 and the second portion P2 are inclined with respect to the first direction (Z direction) orthogonal to the XY plane.

Specifically, the first portion P1 is formed in a manner of approaching the axis AX of the inductor wire 150 (in a manner of being inclined inward in the radial direction of the inductor wire 150) toward the forward Z direction side. The second portion P2 is formed in a manner of being separated from the axis AX of the inductor wire 150 (in a manner of being inclined outward in the radial direction of the inductor wire 150) toward the forward Z direction side. The inclination directions of the first portion P1 and the second portion P2 are not particularly limited. The first portion P1 may be formed in a manner of being separated from the axis AX of the inductor wire 150 toward the forward Z direction side. The second portion P2 may be formed in a manner of approaching the axis AX of the inductor wire 150 toward the forward Z direction side.

According to this embodiment, in the section shown in FIG. 2, the first portion P1 and the second portion P2 are disposed parallel to the Z direction. That is, the first portion P1 and the second portion P2 are not inclined with respect to the Z direction. Here “parallel” means that the angle formed by the first portion P1 and the Z direction is less than 5° and the angle formed by the second portion P2 and the Z direction is less than 5°. Thus, at least one of the first portion P1 and the second portion P2 may be inclined with respect to the Z direction in any section among a plurality of sections orthogonal to the extension direction of the inductor wire 150. In other words, the first portion P1 may be inclined with respect to the Z direction in at least a part of the innermost periphery of the inductor wire 150, and the second portion P2 may be inclined with respect to the Z direction in at least a part of the outermost periphery of the inductor wire 150.

According to the inductor component 1, in a section orthogonal to the extension direction of the inductor wire 150, the sectional area of the inductor wire 150 can be increased as compared with the case where at least one of the first portion P1 and the second portion P2 is not inclined with respect to the Z direction, and thus the electrical resistance of the inductor wire 150 can be reduced.

Preferably, as shown in FIG. 3, in a section orthogonal to the extension direction of the inductor wire 150, an angle formed by at least one of the first portion P1 and the second portion P2 and the XY plane (in other words, the upper surface of the underlying insulation layer 70) is 45° or more and 85° or less (i.e., from 45° to 85°). Here, the angle formed by the first portion P1 and the XY plane refers to the angle on the side closer to the inner magnetic path out of the angles formed by the first portion P1 and the XY plane (that is, two angles including an acute angle and an obtuse angle). The angle formed by the second portion P2 and the XY plane refers to the angle on the side closer to the outer magnetic path out of the angles formed by the second portion P2 and the XY plane (that is, two angles including an acute angle and an obtuse angle).

Specifically, an angle θ1 formed by the first portion P1 and the XY plane is 45° or more and 85° or less (i.e., from 45° to 85°). An angle θ2 formed by the second portion P2 and the XY plane is 45° or more and 85° or less (i.e., from 45° to 85°). When the first portion P1 is not linear but curved, for example, the formed angle θ1 may be an angle closer to the inner magnetic path out of the angles formed by the XY plane and a straight line, which passes through a corner portion C1 on the forward Z direction side of the first portion P1 and a corner portion C2 on the reverse Z direction side of the first portion P1. Similarly, when the second portion P2 is not linear but curved, for example, the formed angle θ2 may be an angle closer to the outer magnetic path out of the angles formed by the XY plane and a straight line, which passes through a corner portion C3 on the forward Z direction side of the second portion P2 and a corner portion C4 on the reverse Z direction side of the second portion P2.

According to the above-described configuration, the formed angle θ1 is 45° or more, and thus, the filling property of the second magnetic layer 12 can be ensured. When the formed angle θ1 is less than 45°, it may be difficult to fill the space between the first portion P1 and the underlying insulation layer 70 with a magnetic powder, particularly a magnetic powder having a particle diameter of several μm or more, and the filling property of the second magnetic layer 12 may deteriorate. The formed angle θ1 is 85° or less, and thus, the electrical resistance of the inductor wire 150 can be effectively reduced. The same effect can be obtained when the formed angle θ2 is 45° or more and 85° or less (i.e., from 45° to 85°).

Preferably, as shown in FIG. 3, the number of turns of the inductor wire 150 is 1 turn or more, and the insulation wall 32 has the third portion P3 other than the first portion P1 and the second portion P2, and in a section orthogonal to the extension direction of the inductor wire 150, the third portion P3, which is disposed adjacent to at least one of the first portion P1 and the second portion P2 in the direction (Y direction) parallel to the XY plane, is disposed parallel to the Z direction. Here “parallel” means that an angle formed by the third portion P3 disposed adjacent to the at least one portion and the Z direction is less than 5°.

Specifically, the third portion P3 disposed adjacent to the first portion P1 in the Y direction (the third portion P3 on the right side in FIG. 3) is disposed parallel to the Z direction. The third portion P3 disposed adjacent to the second portion P2 in the Y direction (the third portion P3 on the left side in FIG. 3) is disposed parallel to the Z direction.

According to the above-described configuration, it is possible to more reliably increase the sectional area of at least one of the portion located at the innermost periphery and the portion located at the outermost periphery of the inductor wire 150, and it is also possible to ensure the sectional area of the portion located between the innermost periphery and the outermost periphery.

Preferably, in a section orthogonal to the extension direction of the inductor wire 150, when at least one of the first portion P1 and the second portion P2 has a width W1 and the third portion P3 disposed adjacent to the at least one of the first portion P1 and the second portion P2 in a direction (Y direction) parallel to the XY plane has a width W2, a relation of 0.8<(W1/W2)/≤1 is satisfied. Here, the width of the first portion P1 refers to the length of the lower surface of the first portion P1 in the wire width direction. The width of the second portion P2 refers to the length of the lower surface of the second portion P2 in the wire width direction. The width of the third portion P3 refers to the length of the lower surface of the third portion P3 in the wire width direction.

Specifically, when the first portion P1 has a width W1a and the third portion P3 (the third portion P3 on the right side in FIG. 3) disposed adjacent to the first portion P1 in the Y direction has a width W2a, a relation of 0.8<(W1a/W2a)/≤1 is satisfied. When the second portion P2 has a width W1b and the third portion P3 (the third portion P3 on the left side in FIG. 3) disposed adjacent to the second portion P2 in the Y direction has a width W2b, a relation of 0.8<(W1b/W2b)/≤1 is satisfied. Each of the widths W1a, W1b, W2a, and W2b is, for example, about 5 μm or more and 15 μm or less (i.e., from 5 μm to 15 μm).

According to the above-described configuration, by satisfying a relation of (W1/W2)/≤1, the width W1 of at least one of the first portion P1 and the second portion P2 can be made smaller than the width W2 of the third portion P3 disposed adjacent thereto in the Y direction. Thus, as will be described later, at least one of the first portion P1 and the second portion P2 can be selectively inclined at the time of developing, and the inductor component 1 having the inclined insulation wall 32 can be easily obtained. Furthermore, the volume of at least one of the first portion P1 and the second portion P2 is reduced and the volume of the second magnetic layer 12 can be increased, and thus, the inductance value can be improved. Further, by satisfying 0.8<(W1/W2), the contact area between the lower surface of at least one of the first portion P1 and the second portion P2 and the upper surface of the underlying insulation layer 70 can be ensured, and the adhesive strength between at least one of the first portion P1 and the second portion P2 and the underlying insulation layer 70 can be ensured.

(Modification)

FIG. 4 is a schematic sectional view illustrating an inductor component 1A according to a modification. FIG. 4 corresponds to FIG. 3.

As shown in FIG. 4, the number of turns of the inductor wire 150 is 1 turn or more, and the insulation wall 32 has the third portion P3 other than the first portion P1 and the second portion P2, and in a section orthogonal to the extension direction of the inductor wire 150, the third portion P3, which is disposed adjacent to at least one of the first portion P1 and the second portion P2 in the direction (Y direction) parallel to the XY plane, is inclined with respect to the Z direction, and the angle formed by at least one of the first portion P1 and the second portion P2 and the XY plane (in other words, the upper surface of the underlying insulation layer 70) is smaller than the angle formed by the third portion P3 disposed adjacent thereto and the XY plane.

Specifically, in the inductor component 1A, the third portion P3 disposed adjacent to the first portion P1 in the Y direction (the third portion P3 on the right side in FIG. 4) is inclined with respect to the Z direction. Specifically, the third portion P3 disposed adjacent to the first portion P1 in the Y direction is formed in a manner of approaching the axis AX of the inductor wire 150 toward the forward Z direction side.

The third portion P3 disposed adjacent to the second portion P2 in the Y direction (the third portion P3 on the left side in FIG. 4) is inclined with respect to the Z direction. Specifically, the third portion P3 disposed adjacent to the second portion P2 in the Y direction is formed in a manner of being separated from the axis AX of the inductor wire 150 toward the forward Z direction side.

The angle θ1 formed by the first portion P1 and the XY plane is smaller than the angle θ3 formed by the third portion P3 disposed adjacent to the first portion P1 in the Y direction and the XY plane. The formed angle θ3 refers to the angle on the side of the first portion P1 out of the angles formed by the third portion P3 disposed adjacent to the first portion P1 in the Y direction and the XY plane (that is, two angles including an acute angle and an obtuse angle). The angle θ2 formed by the second portion P2 and the XY plane is smaller than the angle θ4 formed by the third portion P3 disposed adjacent to the second portion P2 in the Y direction and the XY plane. The formed angle θ4 refers to the angle on the side of the second portion P2 out of the angles formed by the third portion P3 disposed adjacent to the second portion P2 in the Y direction and the XY plane (that is, two angles including an acute angle and an obtuse angle).

According to the above-described configuration, the sectional area of the inductor wire 150 can be made uniform in the extension direction of the inductor wire 150. Thus, a current can efficiently flow through the inductor wire 150. On the other hand, when at least one of the formed angle θ1 and the formed angle θ2 is larger than the angle formed by the third portion P3 which is disposed adjacently and the XY plane, there is a possibility that a portion where the sectional area of the inductor wire 150 becomes smaller occurs and the electrical resistance of the inductor wire 150 increases.

(Manufacturing Method)

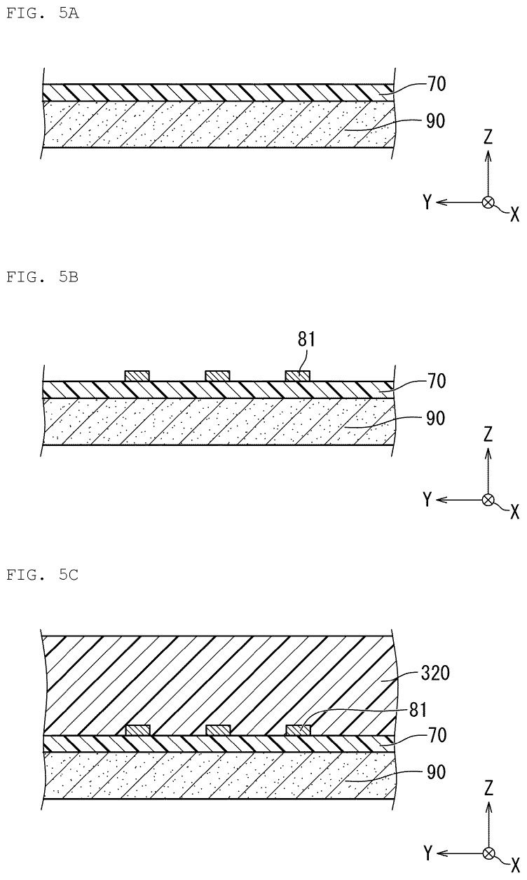

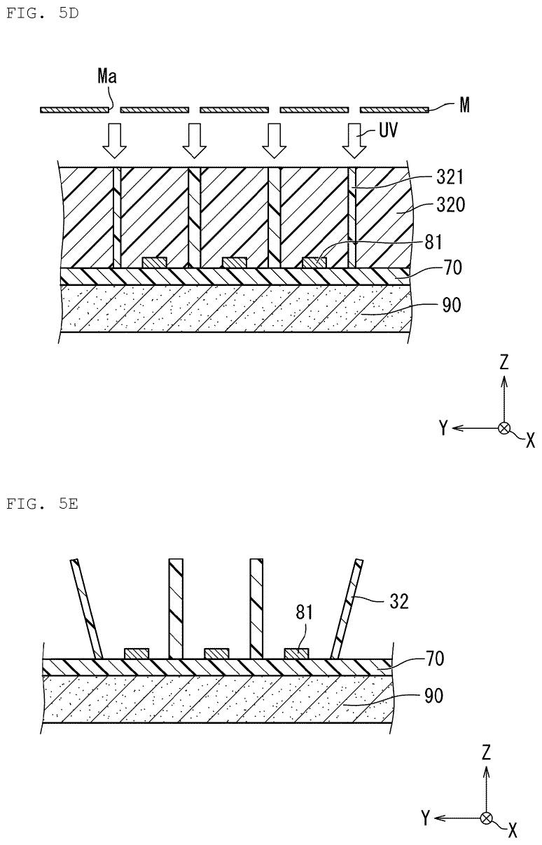

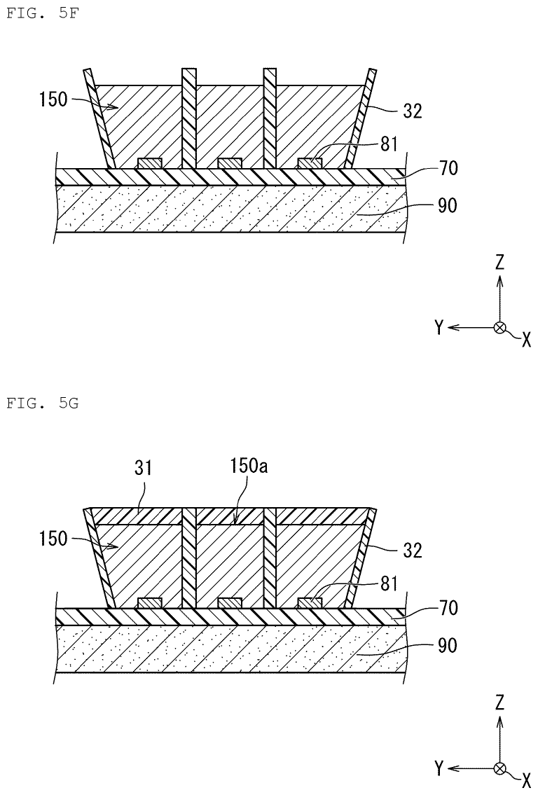

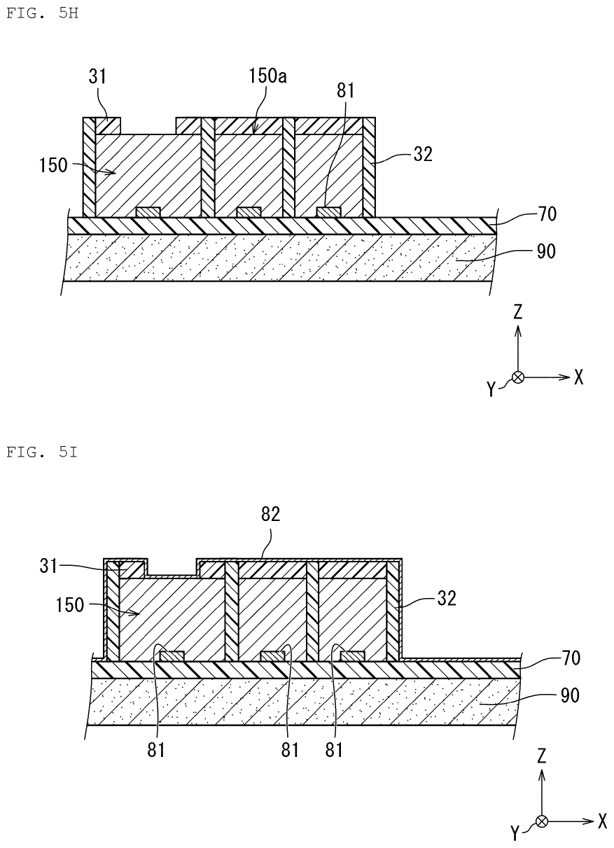

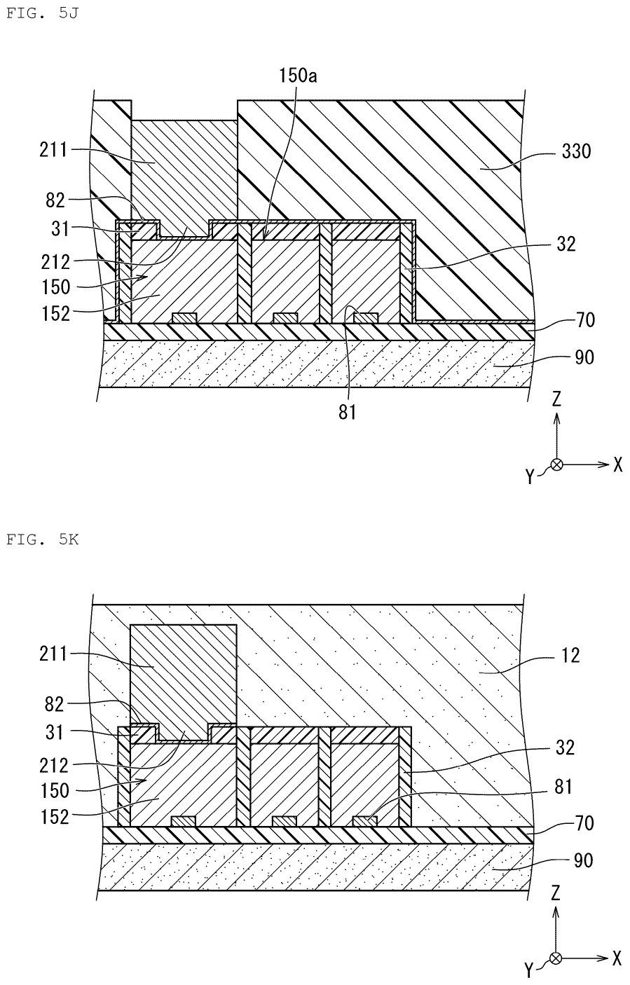

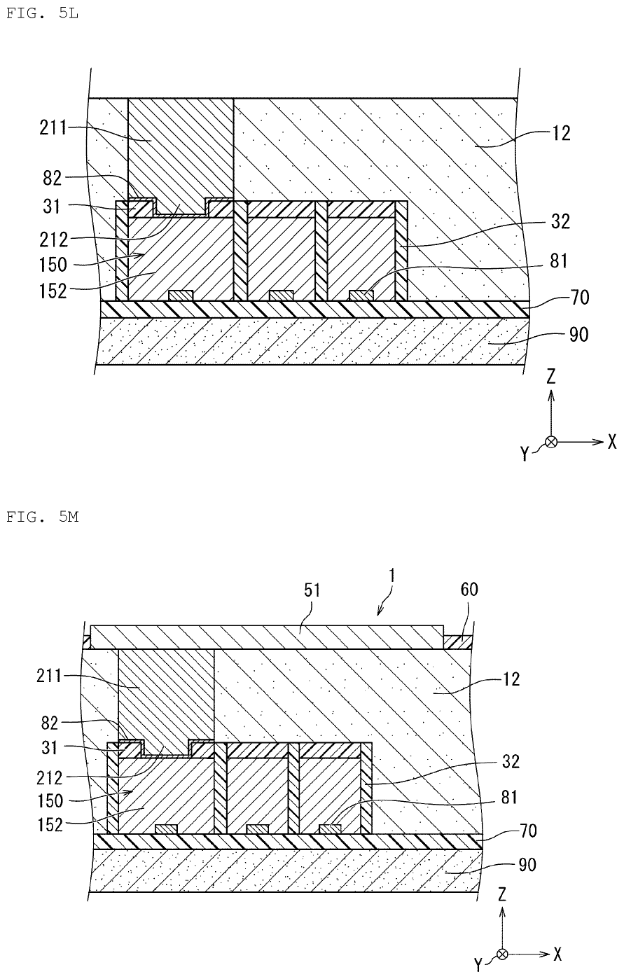

Next, a method of manufacturing the inductor component 1 will be described with reference to FIGS. 5A to 5M. FIGS. 5A to 5G correspond to the III-III section (FIG. 3) of FIG. 1. FIGS. 5H to 5M correspond to the II-II section (FIG. 2) of FIG. 1. In FIGS. 5H to 5M, for convenience, the illustration of the second extended wire side is omitted.

As shown in FIG. 5A, the underlying insulation layer 70 containing no magnetic body is formed on a substrate 90. The substrate 90 is made of, for example, sintered ferrite and has a flat plate shape.

The underlying insulation layer 70 is made of, for example, a polyimide-based resin containing no magnetic body. The underlying insulation layer 70 is formed by coating the polyimide-based resin on the substrate 90 by printing, coating, or the like. After the underlying insulation layer 70 is coated, it may be patterned using a photolithographic method to leave only the polyimide-based resin in the region where the inductor wire 150 is formed. Before the underlying insulation layer 70 is formed, an insulation material serving as a grinding protection layer may be formed on the substrate 90.

As shown in FIG. 5B, a seed layer 81 is formed on the underlying insulation layer 70. Specifically, a material of the seed layer 81 (for example, titanium/copper alloy) is deposited on the upper surface of the underlying insulation layer 70 by sputtering, and is patterned by the photolithography method to form the seed layer 81.

As shown in FIG. 5C, an insulation wall material 320 is deposited on the underlying insulation layer 70. Specifically, for example, a photosensitive permanent photoresist is laminated on the underlying insulation layer 70. A photosensitive permanent photoresist is a photoresist that is not removed after processing.

As shown in FIG. 5D, a photomask M is disposed on the insulation wall material 320, and the insulation wall material 320 is irradiated with ultraviolet rays from the photomask M to expose the insulation wall material 320. An opening Ma having a shape corresponding to the shape of the insulation wall 32 is formed in the photomask M. Thus, after the ultraviolet ray irradiation, an exposed portion 321 having a shape corresponding to the shape of the insulation wall 32 is formed in the insulation wall material 320. At this time, as shown in FIG. 5D, the seed layer 81 is disposed between the adjacent exposed portions 321.

As shown in FIG. 5E, the insulation wall material 320 is developed to remove the insulation wall material 320 other than the exposed portion 312, thereby forming the insulation wall 32. At this time, as will be described in detail later, at least a part of the insulation wall 32 is inclined. Thereafter, heat is applied as necessary to cure the insulation wall 32.

Here, an example of a method of inclining at least a part of the insulation wall 32 will be described. For example, by using a spray developing machine or the like and adjusting the flow rate (for example, 100 mL/min to 300 mL/min inclusive) and the water pressure (for example, 0.1 MPa to 0.3 MPa inclusive) of the developing solution and the rinse liquid at the time of developing the insulation wall material 320, at least a part of the insulation wall 32 can be stressed and inclined. In particular, as an example of a method of selectively inclining only the insulation wall 32 to be inclined, there is a method of setting the width of the other insulation walls 32 to be slightly wider to increase the mechanical strength, or the like. Specifically, for example, when the width of the first portion P1 is W1 and the width of the third portion P3 is W2, a relation of 0.8≤(W1/W2)/≤1 may be satisfied as described above. The first portion P1 is an example of the insulation wall 32 to be inclined, and the third portion P3 is an example of the other insulation walls 32.

As shown in FIG. 5F, electrolytic plating is performed while supplying electric power to the seed layer 81. Thus, the inductor wire 150 is formed between the insulation walls 32.

As shown in FIG. 5G and FIG. 5H, the interlayer insulation layer 31 is formed on a part of the top surface 150a of the inductor wire 150. Specifically, a dry film resist (DFR) is laminated on the top surface 150a of the inductor wire 150, and exposed and developed. Thus, the material of the unexposed portion is removed to form the interlayer insulation layer 31. At this time, the dry film resist located at a portion where the top surface 150a of the inductor wire 150 is in contact with the first and second extended wires 21, 22 is removed.

As shown in FIG. 5I, a seed layer 82 is formed by sputtering in a manner of covering the exposed part of the top surface 150a of the inductor wire 150, the interlayer insulation layer 31, and the insulation wall 32.

As shown in FIG. 5J, the first via wire 212 and the first columnar wire 211 are formed on the second pad portion 152 of the inductor wire 150. Specifically, a resist film 330 is formed on the seed layer 82, and a cavity is provided in the resist film 330 at a position corresponding to the first via wire 212. Thereafter, electrolytic plating is performed while supplying electric power to the seed layer 82 to form a plating layer in the above-described cavity. Thus, the first via wire 212 and the first columnar wire 211 are formed in the cavity. At this time, the second via wire 222 and the second columnar wire 221, which are not illustrated, are also formed.

As shown in FIG. 5K, the resist film 330 is peeled off, the exposed seed layer 82 is removed, and the second magnetic layer 12 is pressure-bonded from above the substrate 90 toward the inductor wire 150.

As shown in FIG. 5L, the upper surface of the second magnetic layer 12 is ground to expose the upper surface of the first columnar wire 211. At this time, the upper surface of the second columnar wire 221, which is not illustrated, is also exposed.

As shown in FIG. 5M, the covering film 60 is formed on the upper surface of the second magnetic layer 12. The covering film 60 is formed of, for example, a solder resist. Thereafter, the substrate 90 is ground to expose the lower surface of the underlying insulation layer 70. Thereafter, the first magnetic layer 11 is pressure-bonded toward the inductor wire 150 from below the underlying insulation layer 70. Thus, the lower surface of the underlying insulation layer 70 is covered with the first magnetic layer 11. Thereafter, the lower surface of the first magnetic layer 11 is ground to adjust the thickness of the first magnetic layer 11. Thereafter, the first external terminal 51 is formed in a manner of covering the upper surface of the first columnar wire 211. At this time, the second external terminal 52 is also formed in a manner of covering the upper surface of the second columnar wire 221, which is not illustrated. Each of the first and second external terminals 51, 52 has, for example, a 3-layer structure of Cu/Ni/Au formed by electroless plating. Thereafter, singulation is performed by a dicer or the like to manufacture the inductor component 1.

### Second Embodiment

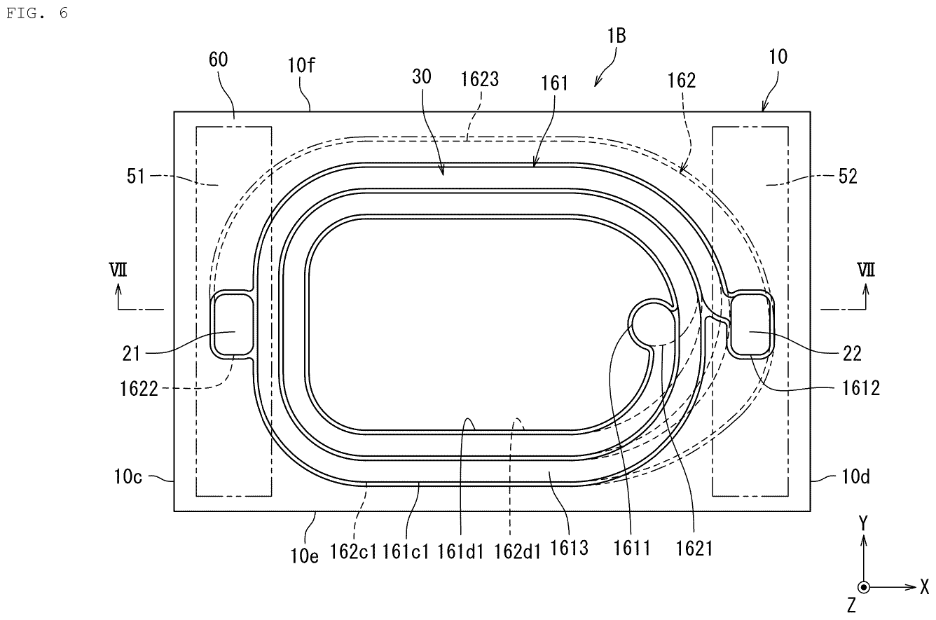

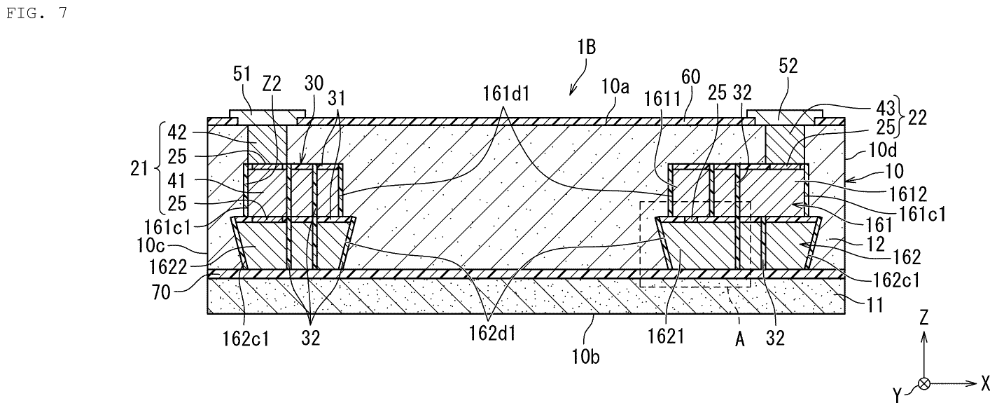

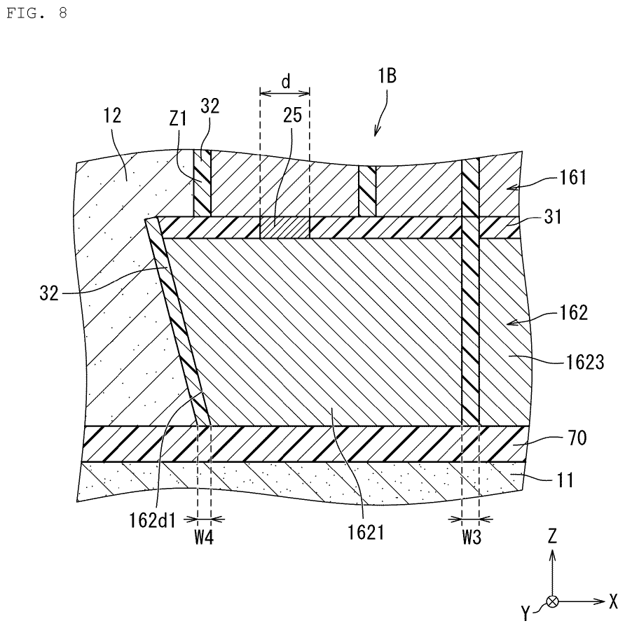

FIG. 6 is a schematic plan view illustrating a second embodiment of the inductor component. FIG. 7 corresponds to a sectional view taken along VII-VII of FIG. 6. FIG. 8 is an enlarged view of a portion A of FIG. 7. The second embodiment is different from the first embodiment mainly in that the inductor wire has 2 layers and the insulation walls provided in the first and second pad portions are also inclined. This different configuration will be described below. The other configurations are the same as those of the first embodiment, and are denoted by the same reference signs as those of the first embodiment, and the description thereof will be omitted.

As shown in FIGS. 6 and 7, an inductor component 1B includes a first inductor wire 161 and a second inductor wire 162 disposed in the element body 10. The second inductor wire 162 corresponds to an example of “inductor wire” recited in the claims. The section shown in FIG. 7 corresponds to an example of “section orthogonal to an extension direction of the inductor wire” recited in the claims.

Each of the first inductor wire 161 and the second inductor wire 162 is wound on the XY plane between the first magnetic layer 11 and the second magnetic layer 12. Specifically, the first magnetic layer 11 exists on the reverse Z direction side with respect to the first inductor wire 161 and the second inductor wire 162, and the second magnetic layer 12 exists in the forward Z direction and in the direction orthogonal to the forward Z direction with respect to the first inductor wire 161 and the second inductor wire 162.

The first inductor wire 161 is a wire that is wound on the XY plane and extends in a spiral shape. According to this embodiment, the number of turns of the first inductor wire 161 is 2 turns. The first inductor wire 161 is spirally wound in a clockwise direction from an inner peripheral end toward an outer peripheral end when viewed from the Z direction. The first inductor wire 161 has an inner peripheral surface 161d1 at the innermost periphery and an outer peripheral surface 161c1 at the outermost periphery.

The first inductor wire 161 includes a wire portion 1613 wound on the XY plane, and a first pad portion 1611 and a second pad portion 1612 provided at the end portions in the extension direction of the wire portion 1613. Specifically, the first pad portion 1611 is provided at the inner peripheral end of the first inductor wire 161, and the second pad portion 1612 is provided at the outer peripheral end of the first inductor wire 161. Each of the first pad portion 1611 and the second pad portion 1612 is formed to be wider than the wire portion 1613.

The second inductor wire 162 is a wire that is disposed on the reverse Z direction side with respect to the first inductor wire 161, is wound on the XY plane, and extends in a spiral shape. The second inductor wire 162 is electrically connected to the first inductor wire 161. According to this embodiment, the number of turns of the second inductor wire 162 is 2.5 turns.

The second inductor wire 162 is spirally wound in a clockwise direction from an outer peripheral end toward an inner peripheral end when viewed from the Z direction. The second inductor wire 162 is disposed between the first inductor wire 161 and the first magnetic layer 11. Thus, each of the first inductor wire 161 and the second inductor wire 162 is disposed in the Z direction. The second inductor wire 162 has an inner peripheral surface 162d1 at the innermost periphery and an outer peripheral surface 162c1 at the outermost periphery.

The second inductor wire 162 includes a wire portion 1623 wound on the XY plane, and a first pad portion 1621 and a second pad portion 1622 provided at the end portions in the extension direction of the wire portion 1623. Specifically, the first pad portion 1621 is provided at the inner peripheral end of the second inductor wire 162, and the second pad portion 1622 is provided at the outer peripheral end of the second inductor wire 162. Each of the first pad portion 1621 and the second pad portion 1622 is formed to be wider than the wire portion 1623. Each of the first and second pad portions 1621,1622 corresponds to an example of “pad portion” recited in the claims.

The second pad portion 1612 of the first inductor wire 161 is connected to the second external terminal 52 with the second extended wire 22, which is in contact with the top surface of the second pad portion 1612, interposed therebetween. The second pad portion 1622 of the second inductor wire 162 is connected to the first external terminal 51 with the first extended wire 21, which is in contact with the top surface of the second pad portion 1622, interposed therebetween. The first pad portion 1621 of the second inductor wire 162 is connected to the first pad portion 1611 of the first inductor wire 161 with a via wire 25, which is in contact with the top surface of the first pad portion 1621, interposed therebetween. With the above configuration, the first inductor wire 161 and the second inductor wire 162 are connected in series and electrically connected to the first external terminal 51 and the second external terminal 52.

The first extended wire 21 is made of a conductive material, extends in the forward Z direction from the top surface of the second inductor wire 162, and penetrates the insides of the insulation layer 30 and the second magnetic layer 12. The first extended wire 21 includes a via wire 25 that is provided on the top surface of the second pad portion 1622 of the second inductor wire 162 and penetrates the inside of the interlayer insulation layer 31, a first columnar wire 41 that extends from the top surface of the via wire 25 in the forward Z direction and penetrates the inside of the second magnetic layer 12, another via wire 25 that is provided on the top surface of the first columnar wire 41 and penetrates the inside of the interlayer insulation layer 31, and a second columnar wire 42 that extends from the top surface of the another via wire 25 in the forward Z direction, penetrates the inside of the second magnetic layer 12, and has an end surface exposed on the first principal surface 10a of the element body 10.

The second extended wire 22 is made of a conductive material, extends in the forward Z direction from the top surface of the first inductor wire 161, and penetrates the inside of the second magnetic layer 12. The second extended wire 22 includes a via wire 25 which is provided on the top surface of the second pad portion 1612 of the first inductor wire 161 and penetrates the inside of the interlayer insulation layer 31, and a third columnar wire 43 which extends in the forward Z direction from the top surface of the via wire 25, penetrates the inside of the second magnetic layer 12, and has an end surface exposed on the first principal surface 10a of the element body 10.

The insulation layer 30 covers the outer surface of the first inductor wire 161 and the outer surface of the second inductor wire 162. According to this embodiment, the interlayer insulation layer 31 of the insulation layer 30 is also disposed between the first inductor wire 161 and the second inductor wire 162. Thus, it is possible to ensure the insulating properties between the first inductor wire 161 and the second inductor wire 162.

The insulation wall 32 provided on the first inductor wire 161 is disposed parallel to the Z direction. Specifically, the first portion of the insulation wall 32 provided on the inner peripheral surface 161d1 of the innermost periphery of the first inductor wire 161, the second portion of the insulation wall 32 provided on the outer peripheral surface 161c1 of the outermost periphery of the first inductor wire 161, and the third portion of the insulation wall 32 provided between the turns of the first inductor wire 161 are each disposed parallel to the Z direction.

The first portion of the insulation wall 32 provided on the inner peripheral surface 162d1 of the innermost periphery of the second inductor wire 162 and the second portion of the insulation wall 32 provided on the outer peripheral surface 162c1 of the outermost periphery of the second inductor wire 162 are inclined with respect to the Z direction. Specifically, the first portion of the insulation wall 32 provided on the inner peripheral surface 162d1 is formed in a manner of approaching the central axis of the second inductor wire 162 toward the forward Z direction side. The second portion of the insulation wall 32 provided on the outer peripheral surface 162c1 is formed in a manner of being separated from the central axis of the second inductor wire 162 toward the forward Z direction side. The third portion of the insulation wall 32 provided between the turns of the second inductor wire 162 is disposed parallel to the Z direction.

As shown in FIG. 8, the first pad portion 1621 of the second inductor wire 162 includes at least one of a part of the inner peripheral surface 162d1 of the innermost periphery of the second inductor wire 162 and a part of the outer peripheral surface 162c1 of the outermost periphery of the second inductor wire 162, and the insulation wall 32 provided on at least one of the above is inclined with respect to the Z direction in a section orthogonal to the extension direction of the second inductor wire 162.

Specifically, the first pad portion 1621 of the second inductor wire 162 includes a part of the inner peripheral surface 162d1 of the innermost periphery of the second inductor wire 162. The insulation wall 32 provided on the part of the inner peripheral surface 162d1 is inclined with respect to the Z direction. More specifically, the insulation wall 32 provided on the part of the inner peripheral surface 162d1 is formed in a manner of approaching the central axis of the second inductor wire 162 toward the forward Z direction side. The insulation wall 32 provided on the part of the inner peripheral surface 162d1 may be formed in a manner of being separated from the central axis of the second inductor wire 162 toward the forward Z direction side.

According to the above-described configuration, the insulation wall 32 provided on the first pad portion 1621 is inclined, and thus, the sectional area of the first pad portion 1621 can be increased, and the electrical resistance of the second inductor wire 162 can be further reduced. In particular, as in the present embodiment, when the insulation wall 32 provided on the part of the inner peripheral surface 162d1 is formed in a manner of approaching the central axis of the second inductor wire 162 toward the forward Z direction side, the area of the upper surface of the first pad portion 1621 can be increased, and thus, a via diameter d of the via wire 25 connected to the first pad portion 1621 can be further increased. Thus, it is possible to improve the adhesion between the via wire 25 and the first and second inductor wires 161,162. In addition, the area of the upper surface of the first pad portion 1621 can be increased, and thus, a margin for exposure alignment of the insulation wall 32 (the insulation wall 32 denoted by a reference sign Z1 in FIG. 8) of the second layer can be ensured without narrowing the wire width of the first inductor wire 161 of the second layer. Thus, when the exposure alignment of the insulation wall 32 of the second layer is deviated, the insulation wall 32 of the second layer can be prevented from being formed away from the interlayer insulation layer 31.

Preferably, as shown in FIG. 8, in a section orthogonal to the extension direction of the second inductor wire 162, the insulation wall 32 provided on the wire portion 1623 is arranged parallel to the Z direction, and when the insulation wall 32 provided on the wire portion 1623 has a width W3 and the insulation wall 32 provided on at least one of the above-described wire portions has a width W4, a relation of 0.5<(W4/W3)<0.8 is satisfied.

Here “parallel” means that an angle formed by the insulation wall 32 provided on the wire portion 1623 and the Z direction is less than 5°. The width W3 refers to the length in the wire width direction of the lower surface of the insulation wall 32 which is provided on the wire portion 1623 and is disposed parallel to the Z direction. Similarly, the width W4 refers to the length in the wire width direction of the lower surface of the insulation wall 32 which is provided on the first pad portion 1621 and is inclined with respect to the Z direction.

According to the above-described configuration, by satisfying the relation of (W4/W3)<0.8, the width W4 of the insulation wall 32 provided on the first pad portion 1621 can be smaller than 0.8 times the width W3 of the insulation wall 32 provided on the wire portion 1623. Thus, the insulation wall 32 provided on the first pad portion 1621 can also be inclined at the time of developing. In addition, by satisfying the relation of 0.5<(W4/W3), the contact area between the lower surface of the insulation wall 32 provided on the first pad portion 1621 and the upper surface of the underlying insulation layer 70 can be ensured, and the adhesive strength between the insulation wall 32 provided on the first pad portion 1621 and the underlying insulation layer 70 can be ensured.

Specifically, when viewed from the Z direction, the outer shape of the wire portion 1623 includes many linear portions. Thus, the insulation wall 32 provided on the wire portion 1623 also has many linear portions when viewed from the Z direction. On the other hand, when viewed from the Z direction, the outer shape of the first pad portion 1621 is often a curved shape (substantially circular according to this embodiment). Thus, the shape of the insulation wall 32 provided on the first pad portion 1621 is also often a curved shape when viewed from the Z direction. The insulation wall 32 having a curved shape when viewed from the Z direction is more resistant to a force received from a direction orthogonal to the Z direction than the insulation wall 32 having a linear shape, and is less likely to be inclined. By satisfying the relation of (W4/W3)<0.8, the insulation wall 32 provided on the first pad portion 1621, which has a curved shape when viewed from the Z direction, can also be inclined due to its relatively smaller width. The method of inclining the insulation wall 32 provided on the first pad portion 1621 is not limited to the above-described method. For example, a method which uses a spray developing machine or a 2-fluid developing machine, etc. and is capable of spraying a chemical solution more strongly than the spray developing machine described in the first embodiment may be employed.

Preferably, as shown in FIG. 7, the second pad portion 1622 of the second inductor wire 162 includes at least one of a part of the inner peripheral surface 162d1 of the innermost periphery of the second inductor wire 162 and a part of the outer peripheral surface 162c1 of the outermost periphery of the second inductor wire 162, and the insulation wall 32 provided on at least one of the above is inclined with respect to the Z direction in a section orthogonal to the extension direction of the second inductor wire 162.

Specifically, the second pad portion 1622 of the second inductor wire 162 includes a part of the outer peripheral surface 162c1 of the outermost periphery of the second inductor wire 162. The insulation wall 32 provided on the part of the outer peripheral surface 162c1 is inclined with respect to the Z direction. More specifically, the insulation wall 32 provided on the part of the outer peripheral surface 162c1 is formed in a manner of being separated from the central axis of the second inductor wire 162 toward the forward Z direction side. The insulation wall 32 provided on the part of the outer peripheral surface 162c1 may be formed in a manner of approaching the central axis of the second inductor wire 162 toward the forward Z direction side.

According to the above-described configuration, the insulation wall 32 provided on the second pad portion 1622 of the second inductor wire 162 is inclined, and thus, the sectional area of the second pad portion 1622 can be increased, and the electrical resistance of the second inductor wire 162 can be further reduced. In particular, when the insulation wall 32 provided on the part of the outer peripheral surface 162c1 is formed in a manner of being separated from the central axis of the second inductor wire 162 toward the forward Z direction side, the area of the upper surface of the second pad portion 1622 can be increased, and thus, the via diameter of the via wire 25 connected to the second pad portion 1622 can be further increased. Thus, it is possible to improve the adhesion among the first extended wire 21, the via wire 25, and the second inductor wire 162. In addition, the area of the upper surface of the second pad portion 1622 can be increased, and thus, a margin for exposure alignment of the insulation wall 32 (the insulation wall 32 denoted by a reference sign Z2 in FIG. 7) of the second layer can be ensured without narrowing the wire width of the first extended wire 21. Thus, when the exposure alignment of the insulation wall 32 of the second layer is deviated, the insulation wall 32 of the second layer can be prevented from being formed away from the interlayer insulation layer 31.

Note that the present disclosure is not limited to the above-described embodiments, and can be modified in design without departing from the gist of the present disclosure. For example, the respective feature points of the first and second embodiments may be variously combined. According to the above-described embodiments, the widths W1 and W2 are compared in the same section, but the widths may be in different sections respectively as long as the sections are orthogonal to the extension direction of the inductor wire 150. The same applies to the widths W3 and W4.

Although the first and second extended wires, the first and second external terminals, the interlayer insulation layer, the underlying insulation layer and the covering film are provided according to the above-described embodiments, these members are not essential and may not be provided or may be replaced with other members.

Although the inductor wire has one layer or two layers according to the above-described embodiments, the inductor wire may have three or more layers.

Although the insulation wall is present in the entire region between the adjacent turns of the inductor wire according to the above-described embodiments, the second magnetic layer may be present between the adjacent turns. Specifically, in a section orthogonal to the extension direction of the inductor wire, the insulation wall may be provided on both side surfaces of the inductor wire and the second magnetic layer may be present between the adjacent turns.

According to the first embodiment described above, in a section orthogonal to the extension direction of the inductor wire, there are 2 third portions of the insulation wall, but when there are 3 or more third portions, i.e., when the number of turns of the inductor wire exceeds 2.5 turns, among these third portions, the third portions other than the third portion disposed adjacent to the first portion and the third portion disposed adjacent to the second portion may be parallel to or inclined with respect to the Z direction.

According to the second embodiment, both the insulation wall provided on the inner peripheral surface of the innermost periphery of the first inductor wire and the insulation wall provided on the outer peripheral surface of the outermost periphery of the first inductor wire are disposed parallel to the Z direction, but at least one of the insulation walls may be inclined with respect to the Z direction. In this case, the first inductor wire corresponds to an example of “inductor wire” recited in the claims.

The present disclosure includes the following aspects.

<1> An inductor component including an element body; an inductor wire that is provided in the element body and wound on a plane; and an insulation wall that is provided on both side surfaces of the inductor wire in a direction orthogonal to an extension direction of the inductor wire and parallel to the plane. The insulation wall including a first portion provided on an inner peripheral surface of an innermost periphery of the inductor wire and a second portion provided on an outer peripheral surface of an outermost periphery of the inductor wire. Also, in a section orthogonal to the extension direction of the inductor wire, at least one of the first portion and the second portion being inclined with respect to a first direction orthogonal to the plane.

<2> The inductor component according to <1>, wherein in the section orthogonal to the extension direction of the inductor wire, the at least one of the first portion and the second portion is inclined in a manner that a width of the inductor wire in a direction parallel to the plane increases toward a forward direction or a reverse direction of the first direction.

<3> The inductor component according to <1> or <2>, wherein in the section orthogonal to the extension direction of the inductor wire, an angle formed by the plane and the at least one of the first portion and the second portion is 45° or more and 85° or less (i.e., from 45° to 85°).

<4> The inductor component according to any one of <1> to <3>, wherein the inductor wire includes a wire portion wound on the plane and a pad portion provided at an end portion in an extension direction of the wire portion. The pad portion includes at least one of a part of the inner peripheral surface of the innermost periphery and a part of the outer peripheral surface of the outermost periphery. Also, the insulation wall provided on the at least one of the part of the inner peripheral surface of the innermost periphery and the part of the outer peripheral surface of the outermost periphery is inclined with respect to the first direction in the section orthogonal to the extension direction of the inductor wire.

<5> The inductor component according to <4>, wherein in the section orthogonal to the extension direction of the inductor wire, the insulation wall provided on the wire portion is disposed parallel to the first direction, and when a width in a direction parallel to the plane of the insulation wall provided on the wire portion is W3 and a width in a direction parallel to the plane of the insulation wall provided on the at least one of the part of the inner peripheral surface of the innermost periphery and the part of the outer peripheral surface of the outermost periphery is W4, a relation of 0.5<(W4/W3)<0.8 is satisfied.

<6> The inductor component according to any one of <1> to <5>, wherein a number of turns of the inductor wire is 1 turn or more. The insulation wall includes a third portion other than the first portion and the second portion. Also, in the section orthogonal to the extension direction of the inductor wire, the third portion, which is disposed adjacent to the at least one of the first portion and the second portion in a direction parallel to the plane, is disposed parallel to the first direction.

<7> The inductor component according to <6>, wherein in the section orthogonal to the extension direction of the inductor wire, when a width in a direction parallel to the plane of the at least one of the first portion and the second portion is W1 and a width in a direction parallel to the plane of the third portion which is disposed adjacent to the at least one of the first portion and the second portion is W2, a relation of 0.8<(W1/W2)/≤1 is satisfied.

<8> The inductor component according to any one of <1> to <5>, wherein a number of turns of the inductor wire is 1 turn or more. The insulation wall includes a third portion other than the first portion and the second portion. Also, in the section orthogonal to the extension direction of the inductor wire, the third portion, which is disposed adjacent to the at least one of the first portion and the second portion in a direction parallel to the plane, is inclined with respect to the first direction, and an angle formed by the plane and the at least one of the first portion and the second portion is smaller than an angle formed by the plane and the third portion which is disposed adjacent to the at least one of the first portion and the second portion.

What is claimed is:

1. An inductor component comprising:
an element body;
an inductor wire which is in the element body and wound on a plane; and
an insulation wall which is on both side surfaces of the inductor wire in a direction parallel to the plane and orthogonal to an extension direction of the inductor wire,
the insulation wall including a first portion on an inner peripheral surface of an innermost periphery of the inductor wire and a second portion on an outer peripheral surface of an outermost periphery of the inductor wire, and
in a section orthogonal to the extension direction of the inductor wire, at least one of the first portion and the second portion being inclined with respect to a first direction orthogonal to the plane.

2. The inductor component according to claim 1, wherein
in the section orthogonal to the extension direction of the inductor wire,
the at least one of the first portion and the second portion is inclined in a manner that a width of the inductor wire in a direction parallel to the plane increases toward a forward direction or a reverse direction of the first direction.

3. The inductor component according to claim 1, wherein
in the section orthogonal to the extension direction of the inductor wire,
an angle defined by the plane and the at least one of the first portion and the second portion is from 45° to 85°.

4. The inductor component according to claim 1, wherein
the inductor wire includes a wire portion wound on the plane and a pad portion at an end portion in an extension direction of the wire portion,
the pad portion includes at least one of a part of the inner peripheral surface of the innermost periphery and a part of the outer peripheral surface of the outermost periphery, and
the insulation wall on the at least one of the part of the inner peripheral surface of the innermost periphery and the part of the outer peripheral surface of the outermost periphery is inclined with respect to the first direction in a cross section orthogonal to the extension direction of the inductor wire.

5. The inductor component according to claim 4, wherein
in the section orthogonal to the extension direction of the inductor wire,
the insulation wall on the wire portion is parallel to the first direction, and
when a width of the insulation wall on the wire portion in a direction parallel to the plane is W3 and a width of the insulation wall in a direction parallel to the plane on the at least one of the part of the inner peripheral surface of the innermost periphery and the part of the outer peripheral surface of the outermost periphery is W4, a relation of 0.5<(W4/W3)<0.8 is satisfied.

6. The inductor component according to claim 1, wherein
a number of turns of the inductor wire is 1 turn or more,
the insulation wall includes a third portion other than the first portion and the second portion, and
in the section orthogonal to the extension direction of the inductor wire,
the third portion, which is adjacent to the at least one of the first portion and the second portion in a direction parallel to the plane, is parallel to the first direction.

7. The inductor component according to claim 6, wherein
in the section orthogonal to the extension direction of the inductor wire,
when a width of the at least one of the first portion and the second portion in a direction parallel to the plane is W1 and a width of the third portion which is adjacent to the at least one of the first portion and the second portion in a direction parallel to the plane is W2, a relation of 0.8<(W1/W2)/≤1 is satisfied.

8. The inductor component according to claim 1, wherein
a number of turns of the inductor wire is 1 turn or more,
the insulation wall includes a third portion other than the first portion and the second portion,
in the section orthogonal to the extension direction of the inductor wire,
the third portion, which is adjacent to the at least one of the first portion and the second portion in a direction parallel to the plane, is inclined with respect to the first direction, and
an angle defined by the plane and the at least one of the first portion and the second portion is smaller than an angle defined by the plane and the third portion which is adjacent to the at least one of the first portion and the second portion.

9. The inductor component according to claim 2, wherein
in the section orthogonal to the extension direction of the inductor wire,
an angle defined by the plane and the at least one of the first portion and the second portion is from 45° to 85°.

10. The inductor component according to claim 2, wherein
the inductor wire includes a wire portion wound on the plane and a pad portion at an end portion in an extension direction of the wire portion,
the pad portion includes at least one of a part of the inner peripheral surface of the innermost periphery and a part of the outer peripheral surface of the outermost periphery, and
the insulation wall on the at least one of the part of the inner peripheral surface of the innermost periphery and the part of the outer peripheral surface of the outermost periphery is inclined with respect to the first direction in a cross section orthogonal to the extension direction of the inductor wire.

11. The inductor component according to claim 10, wherein
in the section orthogonal to the extension direction of the inductor wire,
the insulation wall on the wire portion is parallel to the first direction, and
when a width of the insulation wall on the wire portion in a direction parallel to the plane is W3 and a width of the insulation wall in a direction parallel to the plane on the at least one of the part of the inner peripheral surface of the innermost periphery and the part of the outer peripheral surface of the outermost periphery is W4, a relation of 0.5<(W4/W3)<0.8 is satisfied.

12. The inductor component according to claim 2, wherein
a number of turns of the inductor wire is 1 turn or more,
the insulation wall includes a third portion other than the first portion and the second portion, and
in the section orthogonal to the extension direction of the inductor wire,
the third portion, which is adjacent to the at least one of the first portion and the second portion in a direction parallel to the plane, is parallel to the first direction.

13. The inductor component according to claim 12, wherein
in the section orthogonal to the extension direction of the inductor wire,
when a width of the at least one of the first portion and the second portion in a direction parallel to the plane is W1 and a width of the third portion which is adjacent to the at least one of the first portion and the second portion in a direction parallel to the plane is W2, a relation of 0.8<(W1/W2)/≤1 is satisfied.

14. The inductor component according to claim 2, wherein
a number of turns of the inductor wire is 1 turn or more,
the insulation wall includes a third portion other than the first portion and the second portion,
in the section orthogonal to the extension direction of the inductor wire,
the third portion, which is adjacent to the at least one of the first portion and the second portion in a direction parallel to the plane, is inclined with respect to the first direction, and
an angle defined by the plane and the at least one of the first portion and the second portion is smaller than an angle defined by the plane and the third portion which is adjacent to the at least one of the first portion and the second portion.
